(19) United States
(12) Patent Application Publication
(10) Pub. No.: US 2012/0005451 A1
(43) Pub. Date: Jan. 5, 2012

(54) DATA STORAGE DEVICE AND BAD BLOCK MANAGING METHOD THEREOF

(75) Inventors: Joon-ho LEE, Hwaseong-si (KR); Mincheol KWON, Seoul (KR); Namyoon WOO, Suwon-si (KR)

(73) Assignee: Samsung Electronics Co., Ltd, Suwon-si (KR)

(21) Appl. No.: 13/175,361

(22) Filed: Jul. 1, 2011

(30) Foreign Application Priority Data
Jul. 2, 2010 (KR) 10-2010-0064049

(51) Int. Cl. G06F 12/10

(52) U.S. Cl. 711/203; 711/E12.068

(57) ABSTRACT

A data storage device includes a storage unit, and a controller configured to control the storage unit, wherein the controller is configured to manage a mapping between a logical address space and a virtual address space of the storage unit, virtual address space of the storage unit being variable.

### CROSS-REFERENCE TO RELATED APPLICATIONS

This application claims priority under 35 U.S.C §119, of Korean Patent Application No. 10-2010-0064049 filed Jul. 2, 2010, the entirety of which is incorporated by reference herein.

### BACKGROUND OF THE INVENTION

1. Field of the Invention

Exemplary embodiments of the present general inventive concept relate to a data storage device to manage a bad block of a storage unit.

2. Description of the Related Art

Semiconductor memory devices are a microelectronic component commonly found in digital logic systems, such as computers, and microprocessor-based applications ranging from satellites, consumer electronics, and so on. According to improvement in the fabrication of semiconductor memory devices, including process enhancements and circuit-design-related developments that allow scaling to higher memory densities and faster operating speeds, performance standards have been established for digital logic systems and other application systems using the semiconductor memory devices.

Semiconductor memory devices generally include volatile memory devices, such as random access memory (RAM) devices, and nonvolatile memory devices. In RAM devices, data is stored by either establishing the logic state of a bistable flip-flop such as in a static random access memory (SRAM), or by charging a capacitor in a dynamic random access memory (DRAM). In both SRAM and DRAM devices, data remains stored and may be read as long as the power is applied, but data is lost when the power is turned off.

Mask read-only memory (MROM), programmable read-only memory (PROM), erasable programmable read-only memory (EPROM) nonvolatile memory electrically erasable programmable read-only memory (EEPROM) devices are capable of storing the data, even with the power turned off. The non-volatile memory data storage state may be permanent or reprogrammable, depending upon the fabrication technology used. Non-volatile semiconductor memories are used for store program and microcode storage in a wide variety of applications in the computer, avionics, telecommunications, and consumer electronics industries. A combination of single-chip volatile as well as non-volatile memory storage modes is also available in devices such as non-volatile SRAM (nvRAM) for use in systems that require fast, reprogrammable non-volatile memory. In addition, dozens of special memory architectures have evolved which contain some additional logic circuitry to optimize their performance for application-specific tasks.

Since mask read-only memory (MROM), programmable read-only memory (PROM) and erasable programmable read-only memory (EPROM) nonvolatile memory devices are not designed to erase and write by system itself, it is difficult to update the contents of the memory. Although electrically erasable programmable read-only memory (EEPROM) nonvolatile memory devices are electrically erasable and writable, a continuous update process should be readily applied to auxiliary memories or system programming memories.

### SUMMARY OF THE INVENTION

The feature and utilities of embodiments of the inventive concept are directed to provide a data storage device including a storage unit, and a controller configured to control the storage unit. The controller is configured to manage a mapping between a logical address space and a virtual address space of the storage unit, virtual address space of the storage unit being variable.

Additional aspects and advantages of the present general inventive concept will be set forth in part in the description which follows and, in part, will be obvious from the description, or may be learned by practice of the general inventive concept.

The feature and utilities of embodiments of the inventive concept may be directed to provide a bad block managing method of a data storage device including a storage unit. The bad block managing method may include determining a virtual address space of the storage unit, and varying the virtual address space of the storage unit discontinuously when a bad block is generated from the storage unit.

The feature and utilities of embodiments of the inventive concept may be directed to provide a data storage device which includes a storage unit including a user data area having a plurality of blocks and a reserved area having a plurality of blocks, and a controller configured to control the storage unit. The controller may include a processing unit, a code RAM to store a flash translation layer and a virtual flash layer to be executed by the processing unit, and a buffer RAM to temporarily store data to be stored in the storage unit. The buffer RAM may store a map table having mapping information between a logical address space and a virtual address space of the storage unit. When a bad block is generated at the storage unit, the virtual flash layer may replace the bad block with a corresponding block of the reserved area to the bad block, and the flash translation layer may update the map table so as to map a virtual block address of the replaced block to a corresponding logical block address to the bad block instead of a virtual block address of the bad block.

The feature and utilities of embodiments of the inventive concept may be directed to provide a data storage device including a storage unit having a virtual block space and a reserved space, and a controller configured to control the storage unit, to set virtual addresses of the virtual block space, the virtual addresses including a virtual address of a block of the reserved space to replace a virtual address of a bad block of the virtual block space, and to perform a request using the previously set virtual addresses of the virtual block space. The virtual block space may be variable according to occurrence of the bad block of the reserved space.

When the request corresponds to the bad block of the virtual block space, the controller may perform the request received from an external device, without determining the bad block of the virtual block space and retrieving information on the virtual address of the block of the reserved space upon receiving the request.

The virtual addresses may not be continuous by replacing the virtual address of the bad block of the virtual block space with the virtual address of the block of the reversed space, and that virtual block space are increased by including the block of the reversed space.

The number of original virtual addresses of the virtual block space may be the same number of the virtual addresses including the virtual address of the block of the reserved space.

The storage unit may include a plurality of sub-storage units each having the virtual block space and the reserved space, the bad block may be one block of one row of the virtual block space of the one sub-storage unit, and the virtual addresses may include a virtual address of one block of one row of the reserved space of the other sub-storage unit.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating a data storage device according to an exemplary embodiment of the inventive concept.

FIG. 2 is a diagram illustrating a bad block managing method of a data storage device illustrated in FIG. 1.

FIG. 3 is a diagram illustrating mapping tables before and after a bad block is generated.

FIG. 4 is a flow chart illustrating an operation of a data storage device according to an exemplary embodiment of the inventive concept.

FIG. 5 is a block diagram illustrating a data storage device according to another exemplary embodiment of the inventive concept.

FIG. 6 is a diagram illustrating a virtual address space managed by a controller illustrated in FIG. 5.

FIG. 7 is a diagram illustrating a mapping table managed by a flash translation layer before and after a bad block is generated.

FIG. 8 is a flow chart illustrating an operation of a data storage device according to still another exemplary embodiment of the inventive concept.

FIG. 9 is a block diagram illustrating a data storage device according to still another exemplary embodiment of the inventive concept.

FIGS. 10A and 10B are diagrams illustrating an unpaired mapping manner describing in FIG. 9.

FIG. 11 is a block diagram illustrating a data storage device according to still another exemplary embodiment of the inventive concept.

FIG. 12 is a block diagram illustrating a controller according to an exemplary embodiment of the inventive concept.

FIG. 13 is a block diagram illustrating storage unit of a data storage device according to an exemplary embodiment of the inventive concept.

FIG. 14 is a block diagram illustrating a computing system including a data storage device according to exemplary embodiments of the inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

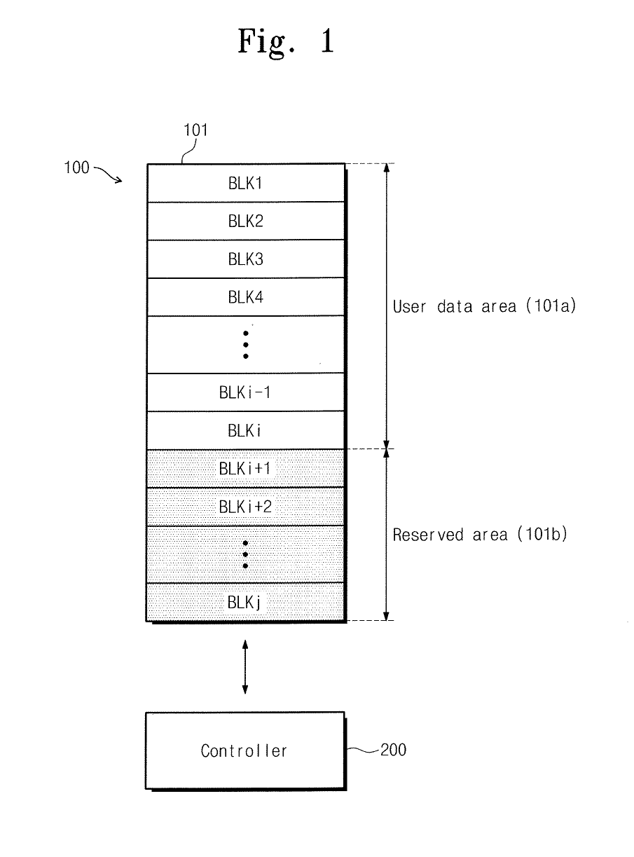

FIG. 1 is a block diagram illustrating a data storage device according to an exemplary embodiment of the inventive concept.

Referring to FIG. 1, a data storage device may include a storage unit 100 which stores M-bit data (M being an integer of one (1) or greater than one). The storage unit 100 may be used to store data information having various data formats such as texts, graphics, software codes, and the like. The storage unit 100 may be formed of non-volatile memory devices such as a PRAM, a FeRAM, a MRAM, and the like, for example. But, it is well comprehended that non-volatile memories applied to the storage unit 100 are not limited to this disclosure. A memory cell array 101 may be implemented to have a two-dimensional array structure or a three-dimensional array structure.

As illustrated in FIG. 1, the storage unit 100 may include the memory cell array 101 which are formed of a plurality of blocks BLK1 to BLKi and BLKi+1 to BLKj. The memory cell array 101 may be divided into a user data area 101a to store user data and a reserved area 101b used to replace bad blocks. Although not shown in FIG. 1, the storage unit 100 may further include well-known elements (for example, a row decoder circuit, a read/write circuit, control logic, a voltage generator circuit, a column decoder circuit, an input/output interface, etc.) enabling accessing to the memory cell array 101.

The data storage device illustrated in FIG. 1 may further include a controller 200 to provide an interface between an external device (for example, a host) and the storage unit 100. For example, the controller 200 may control the storage unit 100 in response to external requests of the external device or a user request input to the data storage device. The controller 200 may manage bad blocks of the user data area 101a using various manners, which will be more fully described hereinafter.

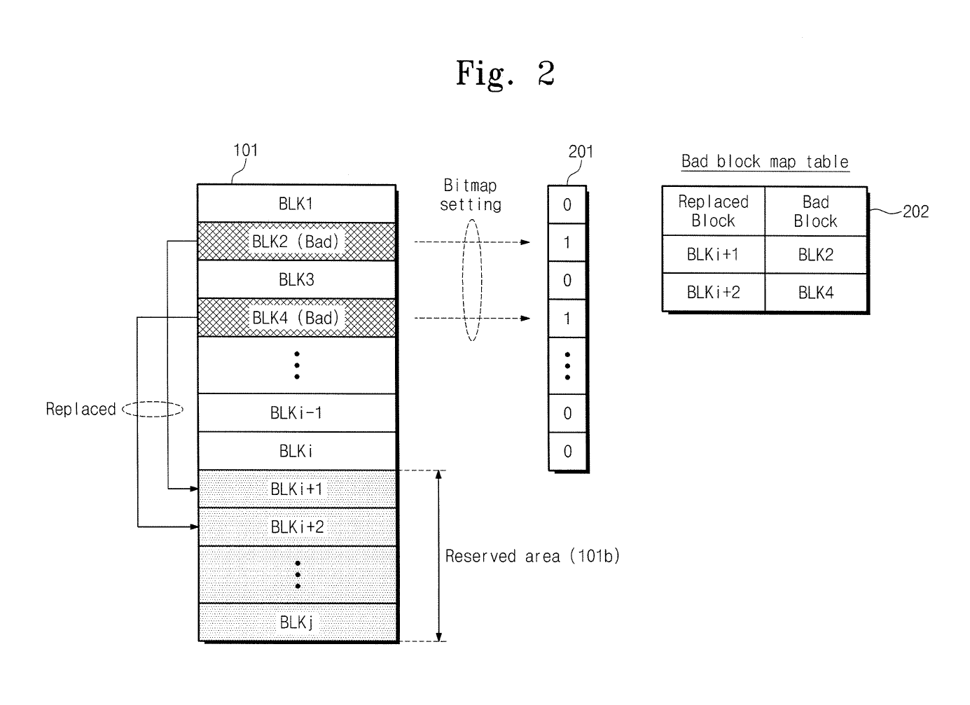

FIG. 2 is a diagram illustrating a bad block managing method of the data storage device illustrated in FIG. 1.

Referring to FIGS. 1 and 2, the controller 200 may manage blocks BLK1 to BLKi and BLKi+1 to BLKj of the memory cell array 101 using virtual addresses. Virtual addresses may be assigned to the blocks BLK1 to BLKi and BLKi+1 to BLKj of the memory cell array 101, respectively. A virtual address assigned to each block is called a virtual block address. The controller 200 may manage the mapping between externally provided addresses (hereinafter, referred to as logical block addresses) and virtual block addresses. When a logical block address is received from an external source, the controller 200 may provide the storage unit 100 with a virtual block address corresponding to a logical block address. The mapping between logical block addresses and virtual block addresses is managed by firmware (or, software) such as a Flash Translation Layer (FTL). The present general inventive concept is not limited thereto. For example, the FTL may be used to manage wear-leveling, data retention due to an unexpected power-off state, and the like with respect to the storage unit 100.

In the event that a block of a user data area 101a is determined as a bad block, the bad block may be replaced with a block in a reserved area 101b. For example, as illustrated in FIG. 2, a bad block BLK2 of the user data area 101 is replaced with a block BLKi+1 of the reserved area 101b, and a bad block BLK4 of the user data area 101 is replaced with a block BLKi+2 of the reserved area 101b. The controller 200 may manage a bitmap 201 to determine whether blocks BLK1 to BLKi of the user data area 101a are a bad block. For example, as illustrated in FIG. 2, bit values of the bitmap 201 corresponding to the respective bad blocks BLK2 and BLK4 of the user data area 101a are set to ‘1’. In the bitmap 201, a bit value of ‘0’ means that a corresponding block to the bit value of ‘0’ is not a bad block.

Here, the bad block may not be used to write or store data therein. The bad block may be prevented from being written thereto that has failed.

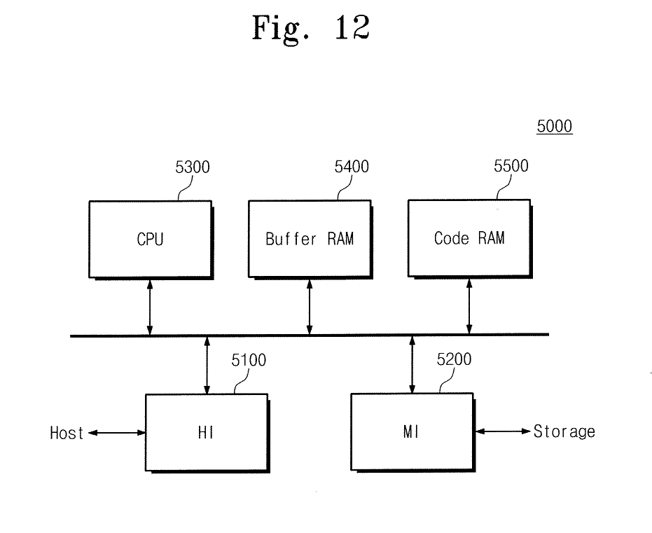

The controller 200 may manage the mapping between bad blocks and replaced blocks. The mapping between bad blocks and replaced blocks may be managed through a bad block map table 202. The bad block map table 202 may be used to determine whether a bad block is replaced with any block of the reserved area 101b. Managing of the bitmap 201 and the bad block map table 202 may be made by a lower layer (hereinafter, referred to as a Virtual Flash Layer (VFL)) of a FTL. The VFL may manage bad blocks in the user data area 101a using the bitmap 201 and the bit block map table 202. Information such as the bitmap, the bad block map table, etc., may be stored temporarily in a buffer RAM of FIG. 12) of the controller 200. The amount of such information may increase in proportion to an increase in bad blocks.

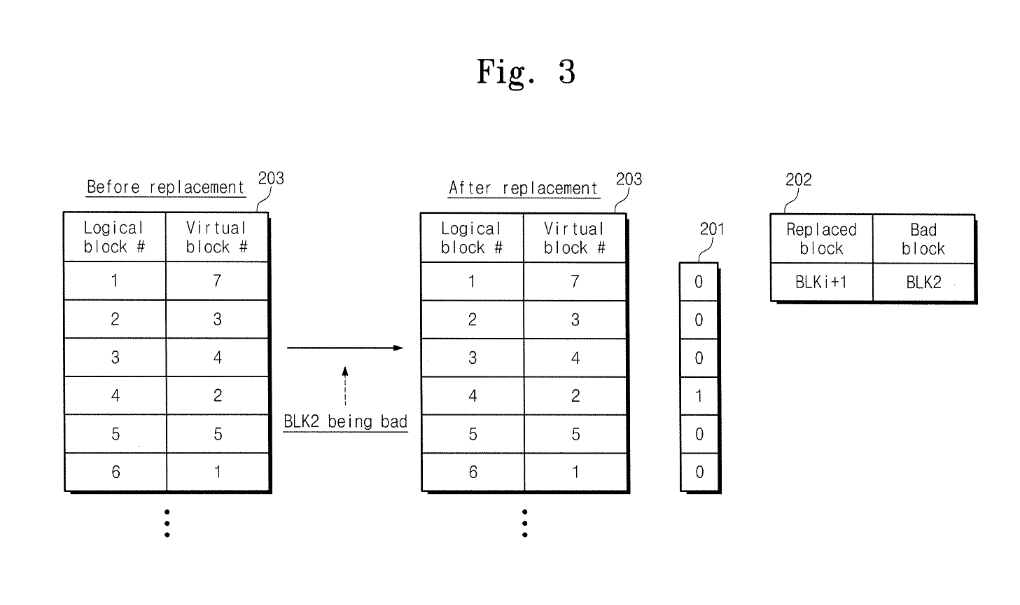

FIG. 3 is a diagram illustrating mapping tables before and after a bad block is generated.

Referring to FIG. 3, the correspondence between logical block addresses and virtual block addresses may be managed by a FTL. The correspondence may be managed through a block map table 203. It is assumed that any block (for example, a virtual block BLK2) is determined to be a bad block. In this case, as illustrated in FIG. 3, the block map table 203 is not changed. This means that a virtual address space of a user data area 101a is not changed. A bitmap 201 and a bad block map table 202 may be changed by a VFL, depending upon a virtual block address provided from the FTL.

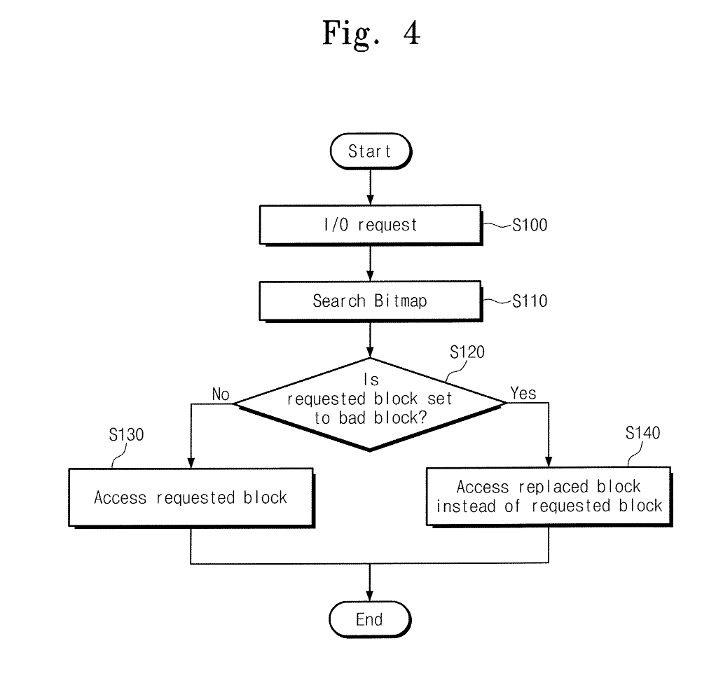

FIG. 4 is a flow chart illustrating an operation of a data storage device according to an exemplary embodiment of the inventive concept.

Referring to FIGS. 1 through 4, in operation S100, a controller 200 receives an input/output (I/O) (or, read/write) request from an external source (for example, a host). In step S110, the controller 200 may search a bit value of a bitmap 201 corresponding to the requested block. In operation S120, the controller 200 may judge whether the requested block is a bad block, depending upon the searched bit value. If the requested block is judged not to be a bad block, the procedure goes to operation S130, in which the requested block is accessed. If the requested block is judged to be a bad block, the procedure goes to operation S140, in which a replaced block is accessed instead of the requested block.

For example, when the requested block is a block BLK of FIG. 3 in a user data area 101a, and the block BLK is determined as a bad block, an FTL informs a VFL that an access to the block BLK2 is requested. The VFL may determine whether the access-requested block BLK2 is a bad block, based on the bitmap 201. If the access-requested block BLK2 is a bad block, the VFL determines the access-requested block BLK2 as a block replaced with a block BLKi+1 of a reserved area 101b, based on a bad block map table 202. Accordingly, the replaced block BLKi+1 of the reserved area 101b may be accessed instead of the access-requested block BLK2.

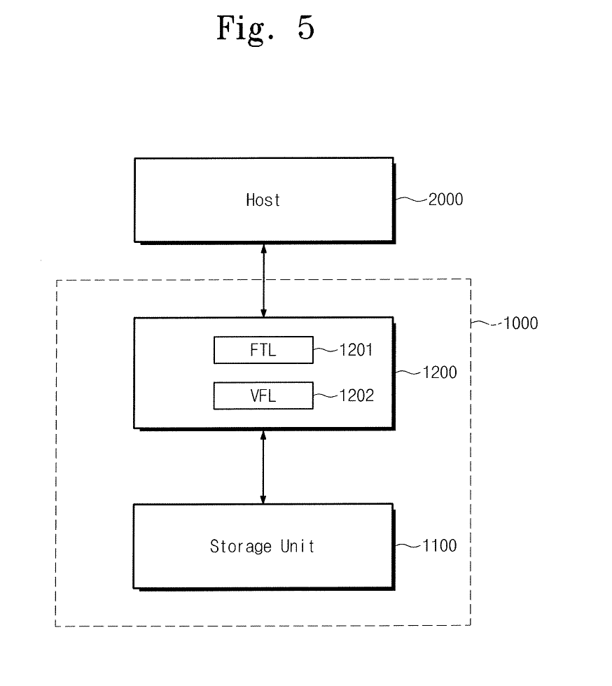

FIG. 5 is a block diagram illustrating a data storage device according to another exemplary embodiment of the inventive concept.

Referring to FIG. 5, a data storage device 1000 may include a storage unit 1100 and a controller 1200. The storage unit 1100 may be implemented to be identical to that illustrated in FIG. 1. For example, the storage unit 1100 may include a memory cell array which is formed of a plurality of blocks BLK1 to BLKi and BLKi+1 to BLKj. The memory cell array may be divided into a user data area to store user data and a reserved area used to replace bad blocks of the user data area.

The controller 1200 may control an access (for example, a read, write, or erase operation) to the storage unit 1100 in response to a request from a host 2000. The controller 1200 may include an FTL 1201 and a VFL 1202. The FTL 1201 may manage the mapping between logical addresses and virtual addresses. The VFL 1202 may manage bad blocks. The FTL 1201 may manage (create, change, modify, delete, update, control, etc.) a virtual address space of the user data area according to one or more bad blocks included in the user data area. In a case where a block is generated, the VFL 1202 replaces the bad block with a block of a reserved area and notifies a virtual address corresponding to the replaced block to the FTL 1201. The FTL 1201 may manage a map table such that a virtual address of the replaced block is mapped to a corresponding logical address instead of a virtual address of the bad block. This means that a virtual address space of the user data area is changed in a discontinuous manner because no virtual address of the bad block is used (or, because a virtual address of the bad block is mapped out from the map table). According to the discontinuous manner, the virtual addresses of the user data area are not continuously arranged to be used for a process of writing and storing data therein, or at least one or more blocks of continuously arranged blocks of the user data area are not used for the process of writing and storing data therein. Since the virtual address of the bad block is replaced with a virtual address of a block of the reserved area, the virtual address of the block of the reserved area is arranged to be used between the virtual addresses of the user data area, for example, to correspond to the virtual address of the replaced bad block.

In a case of the above-described bad block managing manner, since a virtual block address of a block of a reserved area used to replace a bad block is mapped directly with a corresponding logical block address to the bad block by the FTL 1201, it is possible to skip operations of determining whether a block to be accessed is a bad block and whether a bad block is replaced with any block.

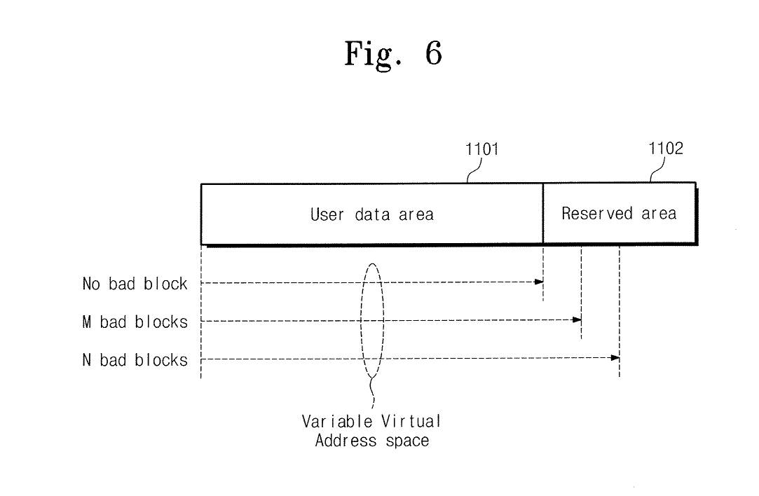

FIG. 6 is a diagram illustrating a virtual address space managed by a controller illustrated in FIG. 5.

As illustrated in FIGS. 5 and 6, a controller 1200 may classify a memory cell array of a storage unit 1100 into a user data area 1101 and a reserved area 1102. The user data area 1101 includes a plurality of blocks to store user data, and the reserved area 1102 includes a plurality of blocks to replace bad blocks of the user data area 1101. The controller 1200 may assign blocks of the user data area 1101 and blocks of the reserved area 1102, respectively. A virtual address space of the user data area 1101 of FIG. 6 may vary according to generation of bad blocks, compared to the virtual address space of the user data area 101a of FIG. 1. For example, as illustrated in FIG. 6, as the number of bad blocks in the user data area 1101 increases, an FTL 1201 increases a virtual address space of the user data area 1101 so as to include a virtual address space of the reserved area 1102. This means that a virtual address space of the reserved area 1102 decreases. In this case, a virtual address space of the user data area 1101 may include a virtual address corresponding to a bad block. Since a virtual address of a bad block is not used (or, a virtual address of a bad block is mapped out from a map table), a virtual address space of the user data area may vary discontinuously.

For example, when the user data area 1101 has M bad blocks, the virtual address space is increased to include corresponding blocks of the reserved area. When the user data area 1101 has N bad blocks, the virtual address space is increased to include corresponding blocks of the reserved area, as illustrated in FIG. 6. The available blocks of the user data area may not be arranged in a continuous manner to be used for a process of writing and storing data therein because of existence of one or more bad blocks disposed between the available blocks and/or because of replacement with corresponding blocks of the reserved area.

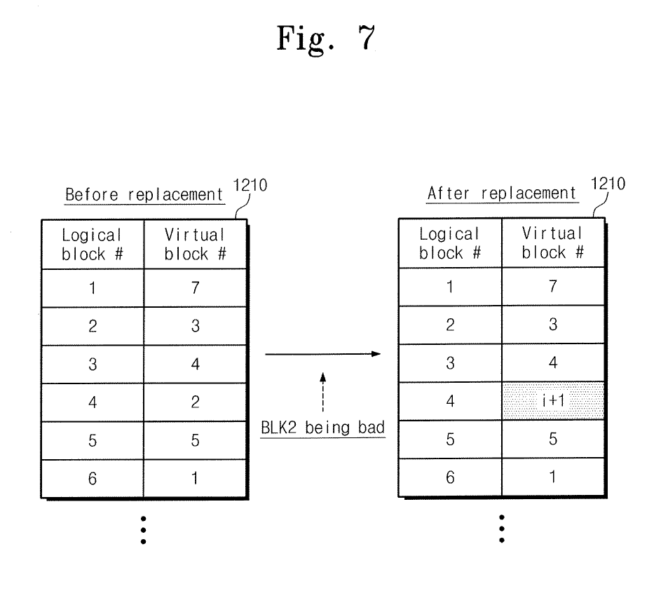

FIG. 7 is a diagram illustrating a mapping table managed by a flash translation layer before and after a bad block is generated.

Referring to FIG. 7, an FTL 1201 manages the mapping between logical block address from a host 2000 and virtual block addresses of a storage unit 1100, according to a block map table 1210. In the event that a block in a user data area 1101 is determined as a bad block, a VFL 1202 replaces the bad block with a block of a reserved area 1102 and notifies a virtual block address corresponding to the replaced block to the FTL 1201. The FTL 1201 manages the block map table 1210 such that a virtual block address of the replaced block is mapped to a corresponding logical address to the bad block. For example, when a virtual block BLK2 is determined to be a bad block, the VFL 1202 replaces the bad block BLK2 with a block (for example, BLKi+1) of the reserved area 1102 and notifies a virtual block address corresponding to the replaced block BLKi+1 to the FTL 1201. The FTL 1201 may manage the block map table 1210 such that a virtual block address of the replaced block BLKi+1 is mapped to a corresponding logical block address to the bad block, which is shown by a hatched portion in FIG. 7.

It is possible to skip processes of determine whether a block to be accessed is a bad block and whether a bad block is replaced with any block, by managing the block map table 1210 so as to include a virtual block address of a replaced block. This means that there may not need to perform a process of storing bitmap information and bad block map information, for example, described in FIGS. 1 to 4.

When one or more blocks are found and determined as bad blocks, information on the bad blocks and replacement blocks of the reserved area is created. Thus, when the data storage device receives a request to write and store data, the data storage device does not have to perform a process of determining the blocks, in which the data is written or stored, as the bad blocks because of the created information on the bad blocks and the replacement blocks. And thus, the data storage device writes and stores the data according to the information without performing a process of storing bitmap information and bad block map information, when the corresponding request is received.

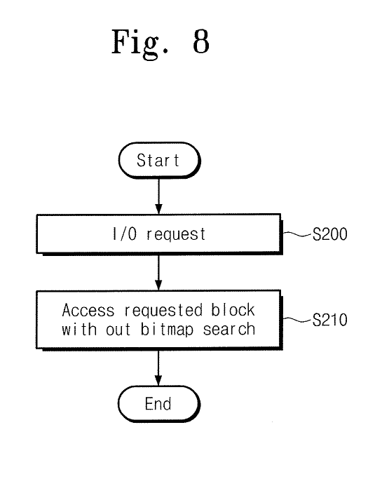

FIG. 8 is a flow chart illustrating an operation of a data storage device according to still another exemplary embodiment of the inventive concept.

In operation S200, a controller 1200 receives an input/output (or, read/write) request from a host 2000. In operation S210, the controller 1200 may access the requested block without bitmap searching. For example, when an access is requested with respect to a normal block included in a user data area 1101, the normal block may be accessed in the same manner as described in FIG. 1. Likewise, in the event that an access is requested with respect to a bad block BLK2, since the bad block BLK2 is replaced with a block BLKi+1 of a reserved area 1102 and a logical block address from the host 2000 is mapped to a virtual block address of the replaced block BLKi+1 instead of the bad block BLK2, the controller 1200 may access the replaced block BLKi+1 without searching of a bitmap and a bad block map table. As described above, the bitmap and the bad block map table are not managed independently by the controller 1200.

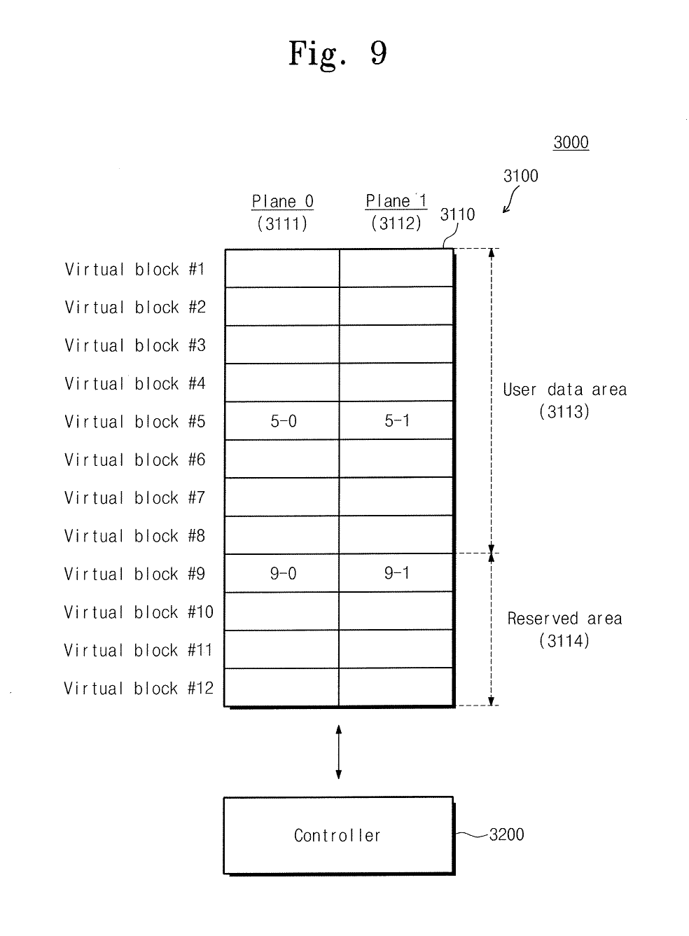

FIG. 9 is a block diagram illustrating a data storage device according to still another exemplary embodiment of the inventive concept.

Referring to FIG. 9, a data storage device 3000 may include a storage unit 3100 and a controller 3200. The storage unit 3100 may include a memory cell array 3110 of a multi-plane structure. The memory cell array 3110 may include two planes 3111 and 3112, for example. Each of the planes 3111 and 3112 may be formed of a plurality of blocks. Blocks of the plane 3111 correspond to blocks of the plane 3112, respectively. The controller 3200 may manage two blocks in each row of the planes 3111 and 3112 as one virtual block. Virtual blocks may be divided into a user data area 3113 and a reserved area 3114. As described above, the user data area 3113 is used to store user data, and the reserved area 3114 is used to replace bad blocks of the user data area 3113. The controller 3200 may be implemented to manage bad blocks according to any one of a paired mapping manner and an unpaired mapping manner.

In a case of the paired mapping manner, when one 5-1 of blocks 5-0 and 5-1 in a virtual block #5 is determined as a bad block, a virtual block #5 including the bad block 5-1 may be replaced with a virtual block #9 (including blocks 9-0 and 9-1) of the reserved area 3114. That is, replacement of the bad block may be made by a virtual block unit. In this case, as described in FIG. 7, a FTL may manage a block map table so as to include a virtual block address of the replaced virtual block.

In a case of the unpaired mapping manner, if one 5-1 of blocks 5-0 and 5-1 in a virtual block #5 is determined as a bad block, only the bad block 5-12 of the blocks 5-0 and 5-1 in the virtual block #5 may be replaced with a block 9-0 or 9-1 in a corresponding virtual block #9 of the reserved area 3114. At this time, a normal block 5-0 of the virtual block #5 including the bad block 5-1 may be used. Likewise, as described in FIG. 7, the FTL may manage the block map table so as to include a virtual block address of the replaced virtual block. Further, if the unpaired mapping manner is used, the VFL may manage a virtual block address of the replaced virtual block and plane information of the replaced block.

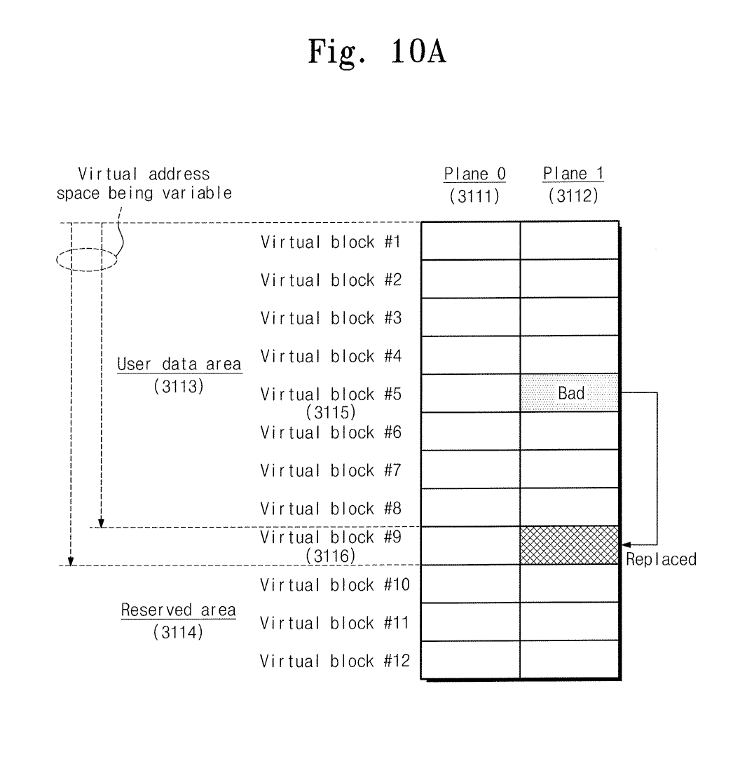

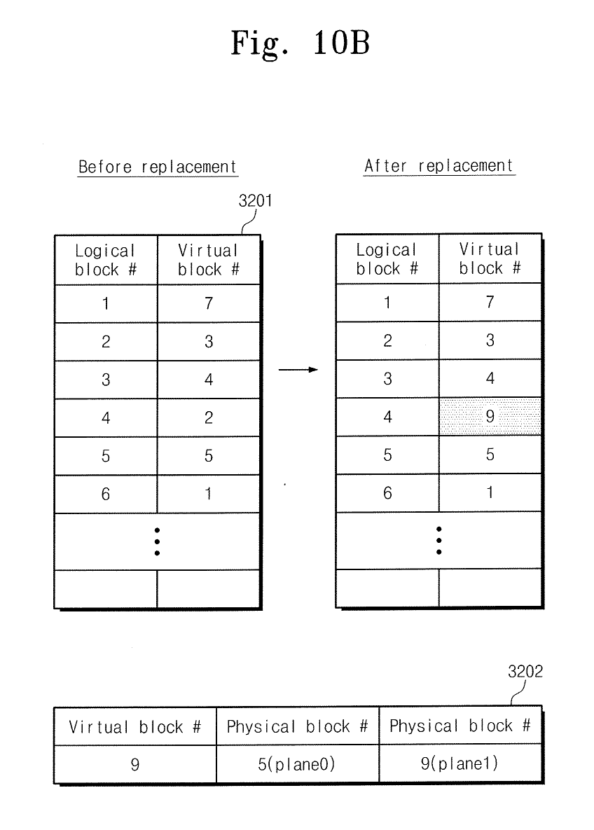

FIGS. 10A and 10B are diagrams illustrating an unpaired mapping manner describing in FIG. 9.

Referring to FIGS. 9, 10A and 10B, when a physical block of a virtual block 3115 in a plane 3112 is a bad block, an FTL may update a block map table 3201 so as to indicate that a logical block 4 corresponds to a corresponding virtual block 3116 of a reserved area 3114. Management of the block map table 3201 may be made in the same manner at an unpaired mapping manner and a paired mapping manner. In the event that the unpaired mapping manner is applied to a controller 3200, it is necessary to manage information on whether a block in any plane is replaced. This may be made through a bad block map table 3202 which is managed by a VFL.

In an exemplary embodiment, it is possible to access a normal block and a replaced block using the bad block map table 3202. For example, when an access is requested with respect to a virtual block 3116, the FTL may provide a virtual block address corresponding to the virtual block 3116 to the VFL. The VFL may judge whether the virtual block address corresponds to a replaced virtual block, depending upon a bitmap. If the virtual block address is judged to be a replaced virtual block, the VFL refers to the bad block map table 3202 and provides address information to a storage unit 3100 so as to access a normal block of the plane 3111 and a replaced block of the plane 3112.

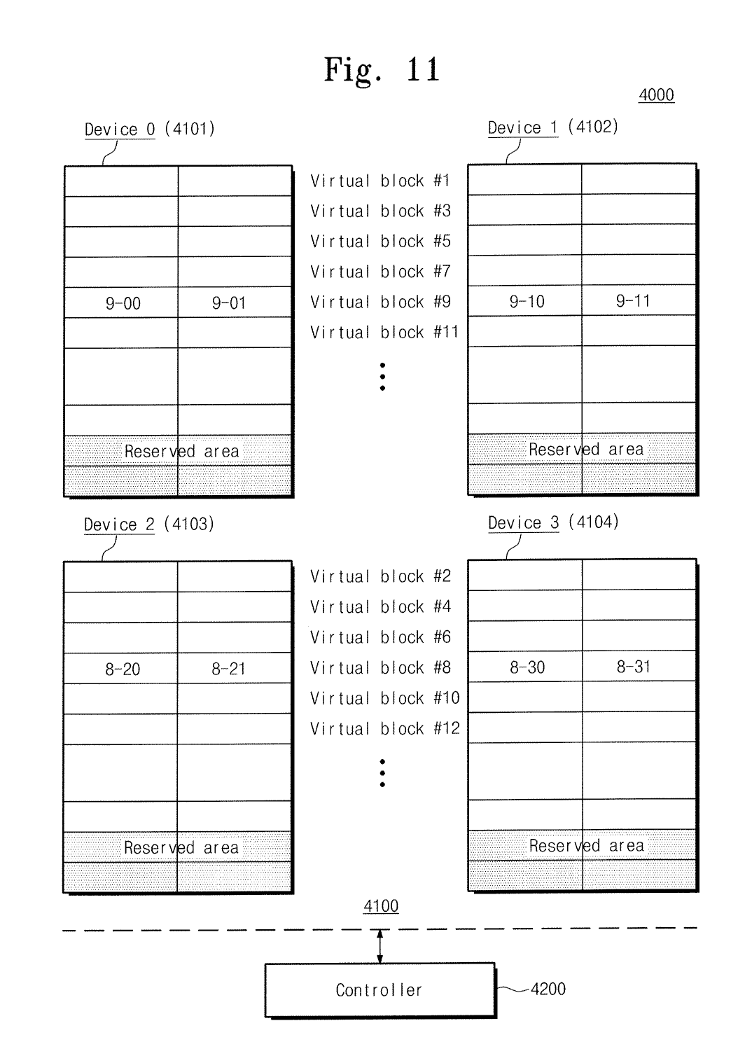

FIG. 11 is a block diagram showing a data storage device according to still another exemplary embodiment of the inventive concept.

Referring to FIG. 11, a data storage device may include a storage unit 4100 and a controller 4200. The storage unit 4100 may include a plurality of, for example, four memory chips (devices) 4101, 4102, 4103, and 4104, each of which may be implemented to have an array structure illustrated in FIG. 1 or 9. FIG. 11 includes an array structure (that is, plane structure) of in FIG. 9, for example. But, an array structure of FIG. 1 may be applied to the storage unit 4100 illustrated in FIG. 11. The controller 4200 may be implemented to manage four blocks (for example, 9-00, 9-01, 9-10, and 9-11) in each row (for example, #9) of two memory chips Device 0 and Device 1 (hereinafter, referred to as a memory chip pair) as one virtual block. Virtual blocks of a memory chip pair (4101, 4102) may be divided into a user data area and a reserved area. Likewise, the controller 4200 may be implemented to manage four blocks (for example, 8-20, 8-21, 8-30, and 8-31) in each row (for example, #8) of two memory chips Device 2 and Device 3 as one virtual block, and virtual blocks of a memory chip pair (4103, 4104) may be divided into a user data area and a reserved area.

As illustrated in FIG. 11, the order of virtual blocks may be determined in a stripping (or skipping) manner, not sequentially (in a sequential manner). The stripping manner may be distinguished from the manner that virtual block addresses are determined sequentially. Sequential determining of virtual block addresses means that a reserved area is provided only in a memory chip pair. On the other hand, reserved areas may be provided in respective memory chip pairs by determining virtual block addresses in the stripping manner. As illustrated in FIG. 11, the controller 4200 may manage virtual block addresses such that virtual blocks of the memory chip pairs (4101, 4102) and (4103, 4104) are accessed in turn. The bad blocks may be managed by stripping virtual block addresses. For example, a bad block generated in any memory chip pair is replaced with a block of a reserved area of the memory chip pair including the bad block. This means that data transfer between a bad block and a replaced block is made without data transfer between memory chip pairs.

That is, one or more bad blocks of Device 0 (4101) can be replaced with a block of the reserved area of Device 0 (4101), which is one of the memory chip pairs, or a block of the reserved area of Device 1 (4102), which is the other one of the memory chip pairs.

FIG. 12 is a block diagram illustrating a controller according to an exemplary embodiment of the inventive concept.

Referring to FIG. 12, a controller 5000 of an exemplary embodiment of the inventive concept may include a first interface 5100, a second interface 5200, at least one CPU 5300 as a processing unit, a buffer RAM 5400, and a code RAM 5500. The first interface 5100 may be configured to interface with an external source (or, a host). The second interface 5200 may be configured to interface with a storage unit. The processing unit, that is, the CPU 5300 may be implemented to control an overall operation of the controller 500. For example, the CPU 5300 may be implemented to operate firmware (or, software) such as FTL, VFL, and the like. The VFL and FTL may operate in the same manner as described in FIGS. 1, 5, 9, and 11, and description thereof is thus omitted. The buffer RAM 5400 may be used to temporarily store data provided from an external source via the first interface 5100. The buffer RAM 5400 may be used to temporarily store data transferred from the storage unit via the second interface 5200. The code RAM 5500, for example, may store codes (FTL, VFL, etc.) loaded from the storage unit when the data storage device is powered on. The codes are able to be stored in a code ROM (not shown) instead of the code RAM.

In an exemplary embodiment, the first interface 5100 of the controller 5000 may be formed of one of computer bus standards, storage bus standards, and iFCPPeripheral bus standards, or a combination of two or more standards. The computer bus standards may includes S-100 bus, Mbus, Smbus, Q-Bus, ISA, Zorro II, Zorro III, CAMAC, FASTBUS, LPC, EISA, VME, VXI, NuBus, TURBOchannel, MCA, Sbus, VLB, PCI, PXI, HP GSC bus, CoreConnect, InfiniBand, UPA, PCI-X, AGP, PCIe, Intel QuickPath Interconnect, Hyper Transport, etc. The storage bus standards may include ST-506, ESDI, SMD, Parallel ATA, DMA, SSA, HIPPI, USB MSC, FireWire (1394), Serial ATA, eSATA, SCSI, Parallel SCSI, Serial Attached SCSI, Fibre Channel, iSCSI, SAS, RapidIO, FCIP, etc. The iFCPPeripheral bus standards may include Apple Desktop Bus, HIL, MIDI, Multibus, RS-232, DMX512-A, EIA/RS-422, IEEE-1284, UNI/O, 1-Wire, I2C, SPI, EIA/RS-485, USB, Camera Link, External PCIe, Light Peak, Multidrop Bus, etc.

The first interface 5100 may include a user input interface to receive a user input to control the controller to perform a writing and storing process to write and/or store data in the storage unit through the second interface 5200.

It is possible that the controller 5000 may communicate with the storage unit without the second interface 5200 if the storage unit is connected to components of the controller 5000 through a data bus.

A data storage device according to exemplary embodiments of the inventive concept, for example, may form a memory card. Although not shown in FIG. 12, the controller 5000 may further comprise an ECC block, a cipher/decipher block, and the like according to applications.

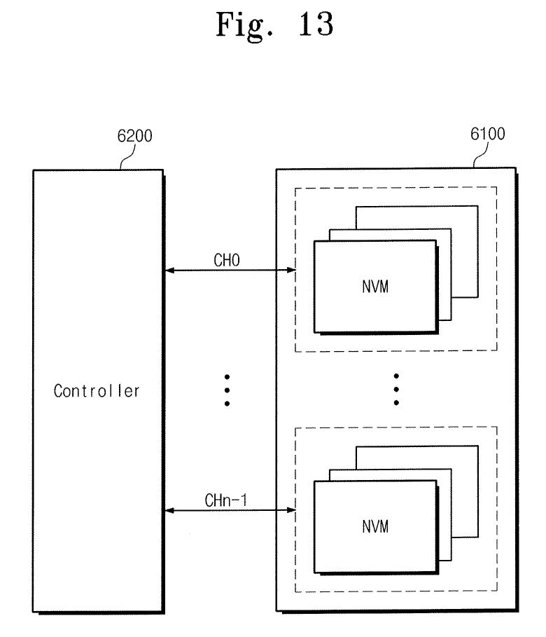

FIG. 13 is a block diagram illustrating a storage unit 6100 of a data storage device according to an exemplary embodiment of the inventive concept.

Referring to FIG. 13, the storage unit 6100 may operate responsive to the control of a controller 6200. The storage unit 6100 may be connected with the controller 6200 via a plurality of channels CH0 to CHn−1. Each of the channels CH0 to CHn−1 may be connected commonly with a plurality of non-volatile memories NVM. The data storage device illustrated in FIG. 13 may be a Solid State Drive (SSD). The controller 6200 illustrated in FIG. 13 may be substantially identical to that in FIG. 1, 5, 9, or 11, and description thereof is thus omitted. Further, each non-volatile memory NVM of the storage unit 6100 illustrated in FIG. 13 may be substantially identical to that in FIG. 1, 9, or 11, and description thereof is thus omitted.

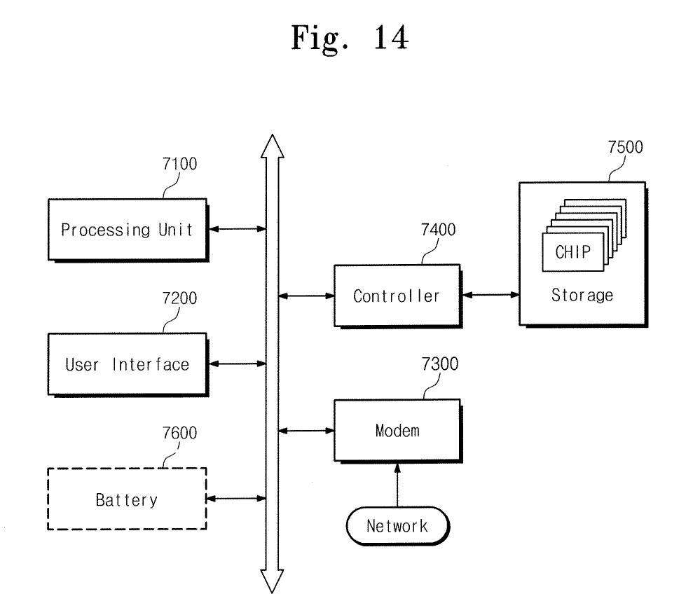

FIG. 14 is a block diagram illustrating a computing system including a data storage device according to exemplary embodiments of the inventive concept.

The computing system includes at least one processing unit (for example, CPU or microprocessor) 7100, a user interface 7200, a modem 7300 such as a baseband chipset, a controller 7400, and a storage unit 7500 formed of non-volatile memory chips. The modem 3300 may be linked with a network via a wire or wireless manner. The controller 7400 and the storage unit 7500 may be substantially identical to those in FIG. 1, 9, or 11, and description thereof is thus omitted. N-bit data (N being 1 or more integer) processed/to be processed by the processing unit 7100 is stored in the storage unit 7500 through the controller 7400. In the event that the computing system is a mobile device, a battery 7600 is further included in the computing system to supply an operating voltage thereto. Although not illustrated in FIG. 9, the computing system further comprises an application chipset, a camera image processor (CIS), a mobile DRAM, and the like.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A data storage device comprising:
a storage unit; and
a controller configured to control the storage unit,
wherein the controller is configured to manage a mapping between a logical address space and a virtual address space of the storage unit, virtual address space of the storage unit being variable.

2. The data storage device of claim 1, wherein the controller varies the virtual address space in discontinuous manner when a bad block is generated in the storage unit.

3. The data storage device of claim 1, wherein the storage unit includes a user data area having a plurality of blocks and a reserved area having a plurality of blocks, and the virtual address space corresponds to the user data area.

4. The data storage device of claim 3, wherein when one of the blocks of the user data area is determined to be a bad block, the controller replaces the bad block with a corresponding block of the reserved area to the bad block and maps a virtual block address of the replaced block to a corresponding logical block address to the bad block instead of a virtual block address of the bad block.

5. The data storage device of claim 4, wherein:
the controller comprises:
a flash translation layer managing the mapping between the logical address space and the virtual address space of the storage unit, and
a virtual flash layer managing the bad block; and
the virtual flash layer provides a virtual block address of the bad block to the flash translation layer, and the flash translation layer maps the virtual block address of the replaced block to a corresponding logical block address of the bad block instead of a virtual block address of the bad block.

6. The data storage device of claim 5, wherein the virtual address space of the user data space is varied discontinuously by mapping the virtual block address of the replaced block to a corresponding logical block address of the bad block instead of a virtual block address of the bad block.

7. The data storage device of claim 6, wherein:
the controller does not manage mapping information of the bad block and the replaced block; and
when an access to a block of the storage unit is requested, the controller accesses the storage unit without determining whether the access-requested block is a bad block.

8. The data storage device of claim 7, wherein the storage unit has a plurality of planes each formed of a plurality of blocks, and the controller manages blocks in each row of the planes as a virtual block.

9. The data storage device of claim 8, wherein when one of blocks in a virtual block is determined to be a bad block, the virtual flash layer replaces the bad block with a block in a plane including the bad block and manages a mapping between the replaced block and a normal block of a virtual block including the bad block.

10. A bad block managing method of a data storage device including a storage unit, the bad block managing method comprising:
determining a virtual address space of the storage unit; and
varying the virtual address space of the storage unit in a discontinuous manner when a bad block is generated from the storage unit.

11. The bad block managing method of claim 10, wherein the storage unit includes a user data area having a plurality of blocks and a reserved area having a plurality of blocks, and the virtual address space corresponds to the user data area.

12. The bad block managing method of claim 11, wherein the varying the virtual address space of the storage unit discontinuously comprises:
replacing the bad block with a corresponding block of the reserved area to the bad block; and
mapping a virtual block address of the replaced block to a corresponding logical block address to the bad block instead of a virtual block address of the bad block.

13. The bad block managing method of claim 12, wherein the virtual address space of the user data space is varied discontinuously by mapping the virtual block address of the replaced block to a corresponding logical block address of the bad block instead of a virtual block address of the bad block.

14. The bad block managing method of claim 13, wherein an access to a block of the storage unit is performed without determining whether the access-requested block is a bad block.

15. The bad block managing method of claim 13, wherein the storage unit has a plurality of planes each formed of a plurality of blocks, and the controller manages blocks in each row of the planes as a virtual block.

16. A data storage device comprising:
a storage unit having a virtual block space and a reserved space; and
a controller configured to control the storage unit, to set virtual addresses of the virtual block space, the virtual addresses including a virtual address of a block of the reserved space to replace a virtual address of a bad block of the virtual block space, and to perform a request using the previously set virtual addresses of the virtual block space,
wherein the virtual block space is variable according to occurrence of the bad block of the reserved space.

17. The data storage device of claim 16, wherein, when the request corresponds to the bad block of the virtual block space, the controller performs the request received from an external device, without determining the bad block of the virtual block space and retrieving information on the virtual address of the block of the reserved space upon receiving the request.

18. The data storage device of claim 16, wherein the virtual addresses are not continuous by replacing the virtual address of the bad block of the virtual block space with the virtual address of the block of the reversed space, and the virtual block space are increased by including the block of the reversed space.

19. The data storage device of claim 16, wherein the number of original virtual addresses of the virtual block space is the same number of the virtual addresses including the block of the reserved space.

20. The data storage device of claim 16, wherein:
the storage unit comprises a plurality of sub-storage units each having the virtual block space and the reserved space;
the bad block is one block of one row of the virtual block space of the one sub-storage unit; and
the virtual addresses include a virtual address of one block of one row of the reserved space of the other sub-storage unit.
